(19) United States
(12) Patent Application Publication
(10) Pub. No.: US 2021/0352443 A1
(43) Pub. Date: Nov. 11, 2021

(54) Multicast Broadcast Service for 5G New Radio

(71) Applicant: Apple Inc., Cupertino, CA (US)

(72) Inventors: Rohit R. MATOLIA, Surat (IN); Alosious Pradeep PRABHAKAR, Singapore (SG); Han PU, Hong Kong (HK); Krisztian KISS, Hayward, CA (US); Mohammed SADIQUE, Auburn (AU); Srinivasan NIMMALA, San Jose, CA (US); Tong LIU, San Diego, CA (US); Vijay VENKATARAMAN, San Jose, CA (US)

(21) Appl. No.: 17/302,722

(22) Filed: May 11, 2021

(30) Foreign Application Priority Data
May 11, 2020 (IN) 202041019891

(51) Int. Cl. H04W 4/06; H04W 76/10; H04W 28/02

(52) U.S. Cl. CPC H04W 4/06; H04W 28/0268; H04W 76/10

(57) ABSTRACT

Embodiments of a Multicast Broadcast Service (MBS) for 5G New Radio (NR). In one aspect, a user equipment (UE) receives first data from a network via unicast, receives first information from the network, the first information indicating the availability of a multicast service, transmits second information to the network and receives second data from the network via multicast in response to transmitting the second information to the network. In another aspect, a UE receives first information from the network, the first information indicating the availability of a multicast service, receives first data from the network via a multicast session and receives second data from the network via a unicast packet data unit (PDU) session.

### BACKGROUND

A 5G new radio (NR) network may support both unicast and multicast services. Multicast refers to a point-to-multipoint communication scheme where the same data is transmitted from a single source to multiple endpoints at the same time. In contrast to multicast, unicast refers to a point-to-point communication scheme where data is transmitted from a source to a single endpoint. A user equipment (UE) may be configured to receive data via unicast and/or multicast when connected to the 5G NR network.

### SUMMARY

Some exemplary embodiments are directed to a method performed by a user equipment (UE). The method includes receiving first data from a network via unicast, receiving first information from the network, the first information indicating the availability of a multicast service, transmitting second information to the network and receiving second data from the network via multicast in response to transmitting the second information to the network.

Other exemplary embodiments relate to a user equipment (UE) having a transceiver and a processor. The transceiver is configured to communicate with a network. The processor is configured to perform operations that include receiving first data from a network via unicast, receiving first information from the network, the first information indicating the availability of a multicast service, transmitting second information to the network and receiving second data from the network via multicast in response to transmitting the second information to the network.

Still other exemplary embodiments are directed to a method performed by a user equipment (UE). The method includes receiving first information from the network, the first information indicating the availability of a multicast service, receiving first data from the network via a multicast session and receiving second data from the network via a unicast packet data unit (PDU) session.

Still further exemplary embodiments relate to a user equipment (UE) having a transceiver and a processor. The transceiver is configured to communicate with a network. The processor is configured to perform operations that include receiving first information from the network, the first information indicating the availability of multicast service, receiving first data from the network via a multicast session and receiving second data from the network via a unicast packet data unit (PDU) session.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows a schematic overview of an exemplary arrangement of network functions used for Multicast Broadcast Service (MBS) according to various exemplary embodiments.

FIG. 4a shows a signaling diagram for a unicast to multicast handover according to various exemplary embodiments.

FIG. 4b shows a signaling diagram for a unicast to multicast handover according to various exemplary embodiments.

FIG. 5 shows a signaling diagram for a unicast to multicast handover according to various exemplary embodiments.

FIG. 6 shows a signaling diagram for a unicast to multicast handover according to various exemplary embodiments.

FIG. 7 shows a method for multicast to unicast handover based on quality of service (QoS) according to various exemplary embodiments.

FIG. 8 shows a signaling diagram for a multicast to unicast handover according to various exemplary embodiments.

FIG. 9 shows a signaling diagram for a multicast to unicast handover according to various exemplary embodiments.

FIG. 10 shows a signaling diagram for facilitating a unicast to multicast switch for the UE according to various exemplary embodiments.

FIG. 11 shows a signaling diagram for collecting and analyzing data by a network data analytics function (NWDAF) to be used for unicast to multicast switching and vice versa according to various exemplary embodiments.

FIG. 12 shows a signaling diagram for UE and network synchronization with regard to MBS sessions according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing Multicast Broadcast Service (MBS) for 5G New Radio (NR).

MBS generally refers to an aspect of a 5G NR network capable of delivering the same content to multiple recipients. Throughout this description examples of MBS functionality are described with regard to multicast. Multicast refers to a point-to-multipoint communication scheme where data is delivered from a single source to multiple endpoints at the same time. However, reference to multicast service is merely provided for illustrative purposes, those skilled in the art will understand that the exemplary concepts described herein are also applicable to broadcast service.

The 5G NR network may also deliver data via unicast. Unicast refers to a point-to-point communication scheme where data is transmitted from a source to a single endpoint. The exemplary embodiments are described with regard to a user equipment (UE) being configured with a unicast session. Throughout this description, the term “unicast session” may refer to a communication session that is configured to deliver data to the UE via unicast. Various examples are described with regard to the unicast session including a packet data unit (PDU) session. Those skilled in the art will understand that a PDU session generally refers to a logical connection between the UE and a data network. However, any reference to a unicast session or a PDU session is merely provided for illustrative purposes. Different entities may refer to similar concepts by a different name.

The exemplary embodiments are also described with regard to an MBS session. Throughout this description, the term “MBS session” may refer to a communication session that is configured to deliver data to the UE via multicast. The MBS session may include an “MBS bearer.” Similar to the function of the PDU session, the MBS bearer may deliver data from a source to the UE through the 5G NR network. Any reference to an MBS session or an MBS bearer is merely provided for illustrative purposes. Different entities may refer to similar concepts by a different name.

The exemplary embodiments include various MBS session management techniques performed at the UE, at the radio access network (RAN) level and/or at the core network level. In a first aspect, the exemplary MBS session management techniques relate to establishing an MBS session for a UE that is currently configured with a unicast session. In a second aspect, the exemplary MBS session management techniques relate to establishing a unicast session for a UE that is currently configured with a multicast session. These exemplary techniques may be used with other currently implemented MBS management techniques, future implementations of MBS management techniques or independently from other MBS management techniques. Specific examples of these exemplary aspects will be described in more detail below.

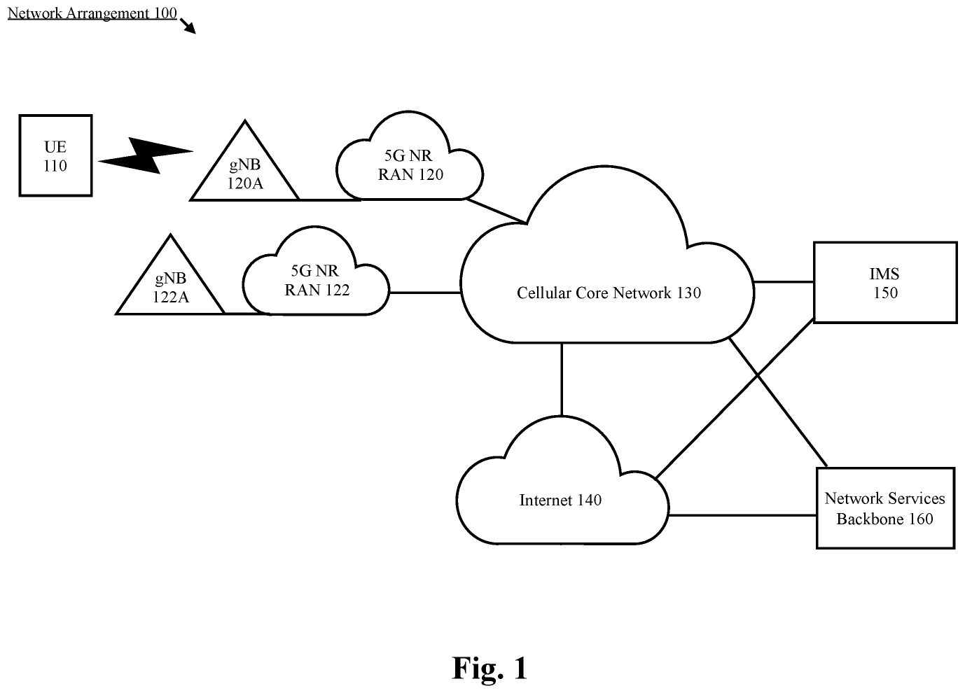

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, eMTC devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the networks with which the UE 110 may wirelessly communicate are 5G New Radio (NR) radio access networks (5G NR-RAN) 120, 122. However, it should be understood that the UE 110 may also communicate with other types of networks (e.g. LTE, legacy cellular network, WLAN, etc.) and the UE 110 may also communicate with networks over a wired connection. The examples provided below will describe scenarios in which the UE 110 establishes a connection with the 5G NR RAN 120 or the 5G NR RAN 122.

The 5G NR-RANs 120, 122 may be portions of cellular networks that may be deployed by cellular providers (e.g., Verizon, AT&T, Sprint, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The 5G NR-RANs 120, 122 may include architecture that is capable of providing both 5G NR RAT and LTE RAT services. For example, a next-generation radio access network (NG-RAN) (not pictured) may include a next generation Node B (gNB) that provides 5G NR services and a next generation evolved Node B (ng-eNB) that provides LTE services. The NG RAN may be connected to at least one of the evolved packet core (EPC) or the 5G core (5GC). Thus, reference to the 5G NR-RANs 120, 122 are only provided for illustrative purposes, the exemplary embodiments may apply to any appropriate type of RAN.

Returning to the exemplary network arrangement 100, the UE 110 may connect to the 5G NR RAN 120 via the next generation Node B (gNB) 120A and the 5G NR RAN 122 via gNB 122A. Those skilled in the art will understand that any association procedure may be performed for the UE 110 to connect to the 5G NR RAN 120 or the 5G NR RAN 122. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A of the 5g NR-RAN 120). Similarly, for access to the 5G NR RAN 122 the UE 110 may associate with gNB 122A.

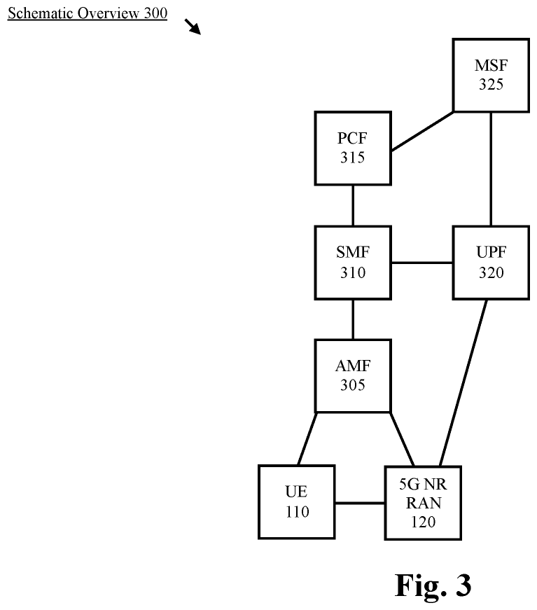

In addition to the 5G NR-RANs 120, 122, the network arrangement 100 also includes a cellular core network 130, the Internet 140, an IP Multimedia Subsystem (IMS) 150, and a network services backbone 160. The cellular core network 130 may be considered to be the interconnected set of components that manages the operation/traffic of the cellular network. The cellular core network 130 also manages the traffic that flows between the cellular network and the Internet 140. A description of the type of network functions within the core network 130 that may be used for MBS will be described below with regard to the schematic overview 300 of FIG. 3.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

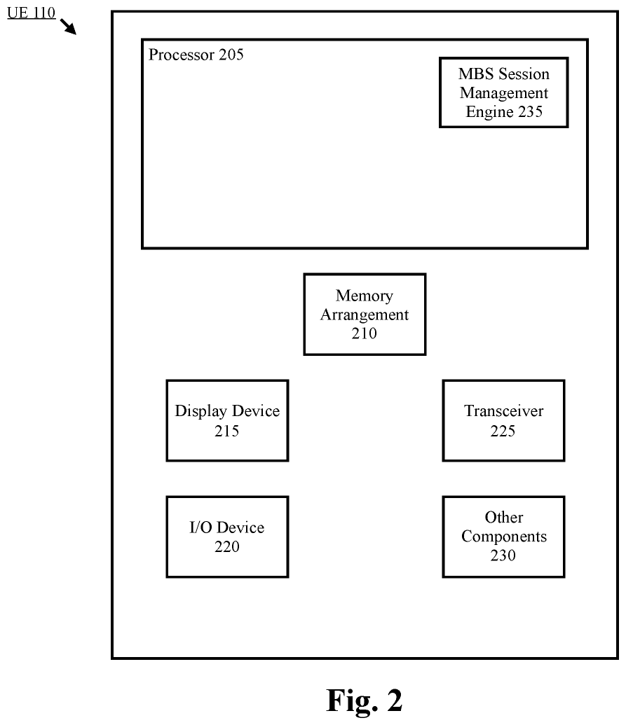

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery, a data acquisition device, ports to electrically connect the UE 110 to other electronic devices, sensors to detect conditions of the UE 110, etc.

The processor 205 may be configured to execute a plurality of engines for the UE 110. For example, the engines may include an MBS session management engine 235. The MBS session management engine 235 may perform various operations related establishing and maintaining an MBS session.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR RANs 120, 122 and other types of wireless networks. Accordingly, the transceiver 225 may operate on a variety of different frequencies or channels (e.g., set of consecutive frequencies).

FIG. 3 shows a schematic overview 300 of an exemplary arrangement of network functions used for MBS according to various exemplary embodiments. The schematic overview 300 will be described with regard to the network arrangement 100 of FIG. 1 and the UE 110 of FIG. 2.

The schematic overview 300 includes the UE 110, the 5G NR RAN 120, an access and mobility management function (AMF) 305, a session management function (SMF) 310, a policy control function (315), a user plane function (UPF) 320 and a multicast service function (325). The functions 305-325 may be considered to be functions of the core network 130, e.g., 5GC. As described above with regard to the network arrangement 100, the UE 110 may camp on the 5G NR RAN 120. Both the UE 110 and the 5G NR RAN 120 may communicate directly with the AMF 305. For example, the UE 110 may communicate with the AMF 305 over a N1 interface and the 5G NR RAN 120 may communicate with the AMF 305 over a N2 interface. Although only a single RAN 120 is shown in the schematic overview 300, these network functions may support more than one RAN (e.g., 5G NR RAN 122).

The AMF 305 may perform operations related to mobility management such as, but not limited to, paging, non-access stratum (NAS) management and registration procedure management between the UE 110 and the core network 130. The AMF 305 may be equipped with one or more communication interfaces (e.g., N1, N2, etc.) to communicate directly or indirectly with other network components (e.g., network functions, RANs, UEs, etc.). The exemplary embodiments are not limited to an AMF that performs the above referenced operations. Those skilled in the art will understand the variety of different types of operations an AMF may perform. Further, reference to a single AMF 305 is merely for illustrative purposes, an actual network arrangement may include any appropriate number of AMFs.

The AMF 305 may also communicate directly with the SMF 310. For example, the AMF 305 may communicate with the SMF 310 over a N11 interface.

The SMF 310 may perform operations related to session management such as, but not limited to, session establishment, session release, IP address allocation, policy and quality of service (QoS) enforcement, etc. The SMF 310 may be equipped with one or more communication interfaces (e.g., N11, etc.) to communicate directly or indirectly with other network components (e.g., network functions, RANs, UEs, etc.). The exemplary embodiments are not limited to an SMF that performs the above referenced operations. Those skilled in the art will understand the variety of different types of operations a SMF may perform. Further, reference to a single SMF 310 is merely for illustrative purposes, an actual network arrangement may include any appropriate number of SMFs.

The SMF 310 may communicate directly with the PCF 315. For example, the SMF 310 may communicate with the PCF 315 over a N7 interface.

The PCF 315 may perform operations related to the control plane such as, but not limited to, managing policy rules for control plane functions including network slicing, roaming and mobility management. The PCF 315 may be equipped with one or more communication interfaces (e.g., N7, etc.) to communicate directly or indirectly with other network components (e.g., network functions, RANs, UEs, etc.). The exemplary embodiments are not limited to an PCF that performs the above referenced operations. Those skilled in the art will understand the variety of different types of operations a PCF may perform. Further, reference to a single PCF 315 is merely for illustrative purposes, an actual network arrangement may include any appropriate number of SMFs.

The SMF 310 and the 5G NR RAN 120 may communicate directly with the UPF 320. For example, the SMF 310 may communicate with the UPF 320 over a N4 interface and the 5G NR RAN 120 may communicate with the UPF 320 over a N3 interface.

The UPF 320 performs operations related packet data unit (PDU) session management and other types of data flow management. For example, the UPF 320 may facilitate a connection between the UE 110 and a data network (e.g., Internet 140) via a N6 interface. The UPF 320 may be equipped with one or more communication interfaces (e.g., N3, N4, N6, etc.) to communicate directly or indirectly with other network components (e.g., network functions, RANs, UEs, etc.). The exemplary embodiments are not limited to an UPF that performs the above referenced operations. Those skilled in the art will understand the variety of different types of operations an UPF may perform. Further, reference to a single UPF 320 is merely for illustrative purposes, an actual network arrangement may include any appropriate number of UPFs.

The PCF 315 and the UPF 320 may communicate directly with the MSF 325. For example, the UPF 320 may communicate with the MSF 325 over a N6 interface and the PCF 315 may communicate with the MSF 325 over the Nnef interface.

The MSF 325 performs operations related to providing multicast service. For example, the MSF 325 may perform operations related to user plane data flow and control plane information for an MBS session. The MSF 325 may be equipped with one or more communication interfaces (e.g. N6, Nnef, etc.) to communicate directly or indirectly with other network components (e.g., network functions, RANs, UEs, etc.). The exemplary embodiments are not limited to an MSF that performs the above referenced operations. Those skilled in the art will understand the variety of different types of operations an MSF may perform. Further, reference to a single UPF 320 is merely for illustrative purposes. In some embodiments, there may be multiple MSFs and/or the functionality of the MSF 325 may be split amongst one or more network functions configured for control plane operations and one or more network functions configured for user plane operations. Thus, an actual network arrangement may include any appropriate number of MSFs.

As indicated above, the UE 110 may receive data during an MBS session via an MBS bearer. MBS bearer context refers to information associated with establishing and maintaining the MBS bearer on the network side. The MBS bearer context may be used for any of a variety of different reasons by one or more components on the data flow path, e.g., the 5G NR RAN 120, the AMF 305, the SMF 310, the UPF 320, the MSF 325, etc. Examples of MBS bearer context parameters that may be used for 5G NR MBS will be described below. However, any reference to a specific parameter is merely provided for illustrative purpose. Different entities may refer to similar concepts by different names.

MBS bearer context may include a tunnel endpoint identifier of the MBS gateway for the control plane (MBS TEID-C). This parameter may be used by the AMF 305 and the SMF 310 for control plane signaling. The MBS bearer context may also include a temporary mobile group identifier (TMGI) that uniquely identifies the MBS bearer service and may be used by all of the components on the data flow path. The MBS bearer context may also include a flow identifier for location dependent sub flow of the MBS bearer service. This parameter may be used by various network functions on the data flow path in conjunction with the TMGI to uniquely identify the MBS bearer service.

MBS bearer context may further include an MSF IP address of the MSF 325 that is used for the control plane and an MSF IP address of the MSF 325 that is used for the user plane. These parameters may be used by AMF 305 and the SMF 310. If the MSF 325 supports multiple address types (e.g., IPv4, IPv6, etc.), both IP addresses may be stored. MBS bearer context may also include a common tunnel endpoint identifier (C-TEID) of the UPF 320 for the user plane. This parameter may be used by the 5G NR RAN 120 and the UPF 320.

MBS bearer context may further include quality of service (QoS) parameters. Those skilled in the art will understand that QoS parameters relate to a quality of service metric that the MBS bearer service may be required to satisfy. This parameter may be used by all of the network components on the data flow path. MBS bearer context may also include a MBS service area which relates to a geographical area over which MBS bearer service may be distributed. This parameter may be used by all of the network components on the data flow path.

MBS bearer context may further include a list of downstream nodes that have requested the MBS bearer service and to which notification are to be forwarded. This parameter may be used by the AMF 305 and the SMF 310 to identify the registered multicast service areas. This parameter may also be used by the UPF 320 and further include the SMF/AMF IP address and TEIDs for the control plane. The MBS bearer context may also include IP multicast addresses and IP source addresses for distribution. These IP addresses may identify the channel used for user plane distribution on the backbone portion of the network. The IP addresses may be used by the 5G NR RAN 120, the AMF 305, the SMF 310 and the UF 320. If these components support multiple address types (e.g., IPv4, IPv6, etc.), both IP addresses may be stored. The MBS context may also include a list of cell IDs for which the MBS service may be distributed. The cell IDs may be used by all of the network components on the data flow path.

In addition to MBS bearer context, the UE context may also be used. The UE context refers to information associated with identifying and tracking the UE 110 such that the MBS data flow may successfully reach the UE 110. The UE context may be used for any of a variety of different reasons by one or more components on the data flow path, e.g., the UE 110, the 5G NR RAN 120, the AMF 305, the SMF 310, the UPF 320, the MSF 325, etc. Examples of UE context parameters that may be used for 5G NR MBS will be described below. However, any reference to a specific parameter is merely provided for illustrative purpose. Different entities may refer to similar concepts by different names.

The UE context may include an IP multicast address for identifying an MBS bearer that the UE 110 has joined. This parameter may be used by the UE 110 and various network functions on the data flow path. The UE context may also include an access point name (APN) on which the IP multicast address is defined (in case of separate PDU session for the MBS session). This parameter may be used by the UE 110 and various network functions on the data flow path.

The UE context may further include an IP address of the UPF currently in use (e.g., UPF 320). This parameter may be used by the AMF 305, the SMF 310 and the 5G NR RAN 120. The UE context may also include a TMGI allocated to the MBS bearer. This parameter may be used by the UE 110, the AMF 305, the SMF 310 and the 5G NR RAN 120.

The UE context may further include a tracking area identity (TAI) associated with the UE 110. The TAI may be used by the UE 110, the AMF 305, the SMF 310 and the 5G NR RAN 120. UE context may also include a bearer UD of the PDU context used by the UE 110 to carry internet group management protocol (IGMP) signaling. This parameter may be used by the UE 110, the AMF 05 and the SMF 310.

The UE context may further include an internet mobile subscriber identity (IMSI) and a subscription permanent identifier (SUPI) identifying the UE 110. This parameter may be used across all network components on the data flow path. The UE context may also include a transaction identifier for PDU session for multicast and unicast service. This parameter may be used by the UE 110, the AMF 305 and the SMF 310.

The UE context may further include a TEID for the control plane between the SMF 310 and the UF 320. The UE context may also include an MSF bearer ID that represents a network layer service access point identifier which identifies an MSF UE context. This parameter may be used by the UE 110, the AMF 305 and the SMF 310.

The above examples of MBS bearer context and UE context are not intended to limit the exemplary embodiments in any way. These examples were merely provided as an overview of the type of information that may be used to facilitate the data flow for MBS. In an actual MBS scenario, any appropriate type of context information may be used. Further, any reference to a specific parameter is for illustrative purposes, different entities may refer to similar concepts by a different name.

As mentioned above, in a first aspect, the exemplary MBS session management techniques relate to establishing an MBS session for a UE that is currently configured with a unicast session. Signaling diagrams 400-600 provided below illustrate examples of MBS techniques that may be used in this type of scenario. In a second aspect, the exemplary MBS session management techniques relate to establishing a unicast session for a UE that is currently configured with a multicast session. Method 700 and signaling diagrams 800-900 provided below illustrate examples of MBS techniques that may be used in this type of scenario.

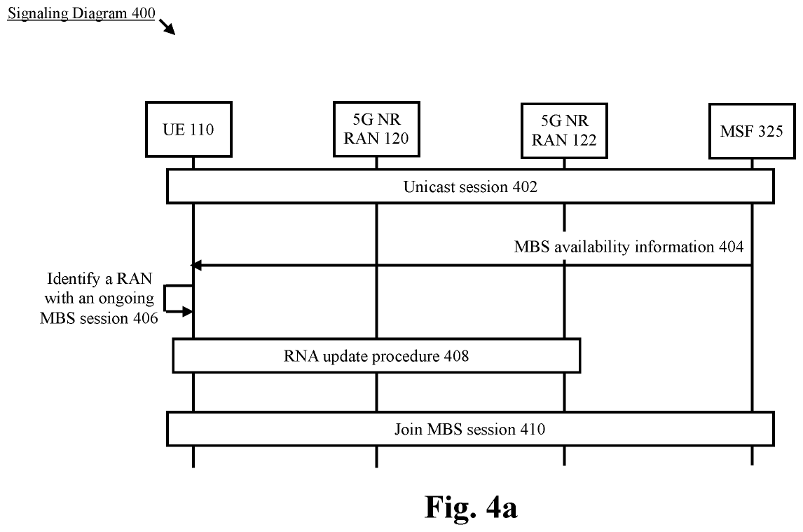

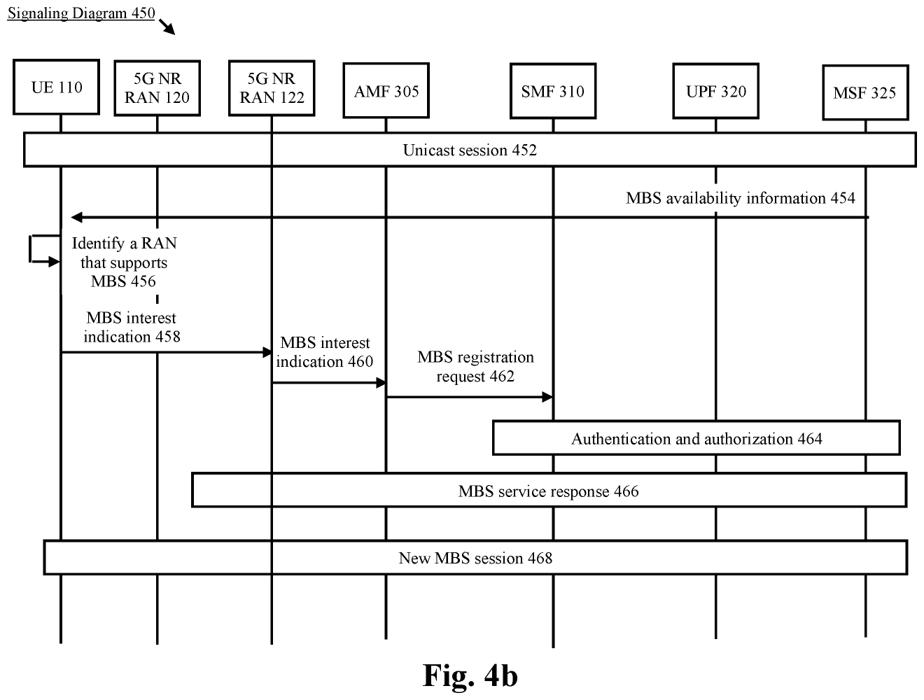

FIG. 4a shows a signaling diagram 400 for a unicast to multicast handover according to various exemplary embodiments. The signaling diagram 400 is described with regard to the network arrangement 100 of FIG. 1, the UE 110 of FIG. 2 and the schematic overview 300 of FIG. 3.

The signaling diagram 400 relates to a scenario in which the UE 110 is currently configured with a unicast session. For example, the UE 110 may be camped on the 5G RAN 120 and receiving multimedia data for a network service via a PDU session. The signaling diagram 400 includes the UE 110, the 5G NR RAN 120, the 5G NR RAN 122 and the MSF 325.

In 402, a unicast session is in progress. In 404, the MSF 325 transmits MBS availability information to the UE 110. The MBS availability information may include an indication of an ongoing MBS session and MBS bearer context such as a TMGI list, a service area list and other session information for the ongoing MBS session. The MBS availability information may travel from the MSF 325 to the UE 110 via the application layer and the user plane. Further, the MBS availability information may be provided to the UE 110 for any appropriate reason such as, but not limited to, an indication of UE 110 mobility, the presence of an ongoing and relevant MBS session within the vicinity of the UE 110, the initiation of an MBS session, etc.

In 406, the UE 110 identifies a RAN with an ongoing MBS session. For example, the UE 110 may be currently camped on the 5G NR RAN 120. The UE 110 may receive an indication that the 5G NR RAN 122 has an ongoing MBS session based, at least in part, on the MBS availability information received in 404. When the UE 110 is in a radio recourse control (RRC) idle or inactive mode, the UE 110 may target the 5G NR RAN 122 during a frequency scan and detect a suitable cell of the 5G NR RAN 122 (e.g., gNB 122A) within the service area list of an ongoing MBS session.

In 408, the UE 110 may perform a RAN notification area (RNA) update procedure. Those skilled in the art will understand the operations associated with performing an RNA update, it is beyond the scope of the exemplary embodiments.

In 410, the UE 110 joins the MBS session from the 5G NR RAN 122. Thus, the UE 110 may now continue to receive the data flow of the MBS session via the multicast. In some embodiments, the unicast PDU session may be released. In other embodiments, the unicast PDU session may be modified. To ensure service continuity, the network may implement a guard timer or a QoS threshold condition prior to releasing or modifying the unicast PDU session.

FIG. 4b shows a signaling diagram 450 for a unicast to multicast handover according to various exemplary embodiments. The signaling diagram 450 is described with regard to the network arrangement 100 of FIG. 1, the UE 110 of FIG. 2 and the schematic overview 300 of FIG. 3.

The signaling diagram 450 includes the UE 110, the 5G NR RAN 120, the 5G NR RAN 122, the AMF 305, the SMF 310, the UPF 320 and the MSF 325. The signaling diagram 450 relates to the same type of scenario as the signaling diagram 400. However, instead of an ongoing MBS session, the signaling diagram 450 relates to initiating a new MBS session.

In 452, a unicast session is in progress. In 454, the MSF 325 transmits MBS availability information to the UE 110. In this example, an indication of an ongoing MBS session may not be included in the MBS availability. Instead, the MBS context for a possible MBS session may be provided.

In 456, the UE 110 identifies a RAN that supports MBS. For example, the UE 110 may receive an indication that the 5G NR RAN 122 supports MBS based, at least in part, on the MBS availability information received in 404. When the UE 110 is in RRC idle or inactive mode, the UE 110 may target the 5G NR RAN 122 during a frequency scan and detect a suitable cell of the 5G NR RAN 122. The UE 110 may now camp on the 5G NR RAN 122 while the unicast session continues.

In 458, the UE 110 may transmit an indication to the 5G NR RAN 122 that the UE 110 is interested in an MBS session. This MBS interest indication may include the UE context such as, but not limited to, SUPI, PDU session ID, application ID, etc. The UE 110 may be triggered to transmit this request for any appropriate reason. In 460, the 5G NR RAN 122 may forward this request to the AMF 305. The 5G NR RAN 122 may include additional information such as a UE ID or a UE group ID.

In 462, the AMF 305 may transmit an MBS registration request to the SMF 310 requesting a new multicast session. The MBS registration request may include information such as, but not limited to, the SUPI associated with the requesting UE (or group of UEs), tracking area information, RAN service are information, etc. In 464, this request along with authentication and authorization information is processed among the various network functions (e.g., the SMF 310, the UPF 320, the MSF 325, and other appropriate network functions) for user plane and control plane activation of a new MBS session.

Depending on the number of devices requesting the MBS and other RAN considerations, the network may decide whether to initiate a new MBS session in response to the MBS registration request. Thus, the UE 110 may implement a timer (or any other appropriate mechanism) and periodically send MBS registrations requests.

In 466, an MBS service response travels via the various network components (e.g., the SMF 310, the UPF 320, the MSF 325, other appropriate network functions and the 5G NR RAN 120) to the 5G NR RAN 120. The MBS session response may include information such as, but not limited to, a session start request, TMGI, a service area identity, etc.

In 468, the UE 110 receives data over the new MBS session via the 5G NR RAN 122. Thus, the UE 110 may now continue to receive the data flow of the MBS session via the multicast. In some embodiments, the unicast PDU session may be released. In other embodiments, the unicast PDU session may be modified. To ensure service continuity, the network may implement a guard timer or a QoS threshold condition prior to releasing or modifying the unicast PDU session.

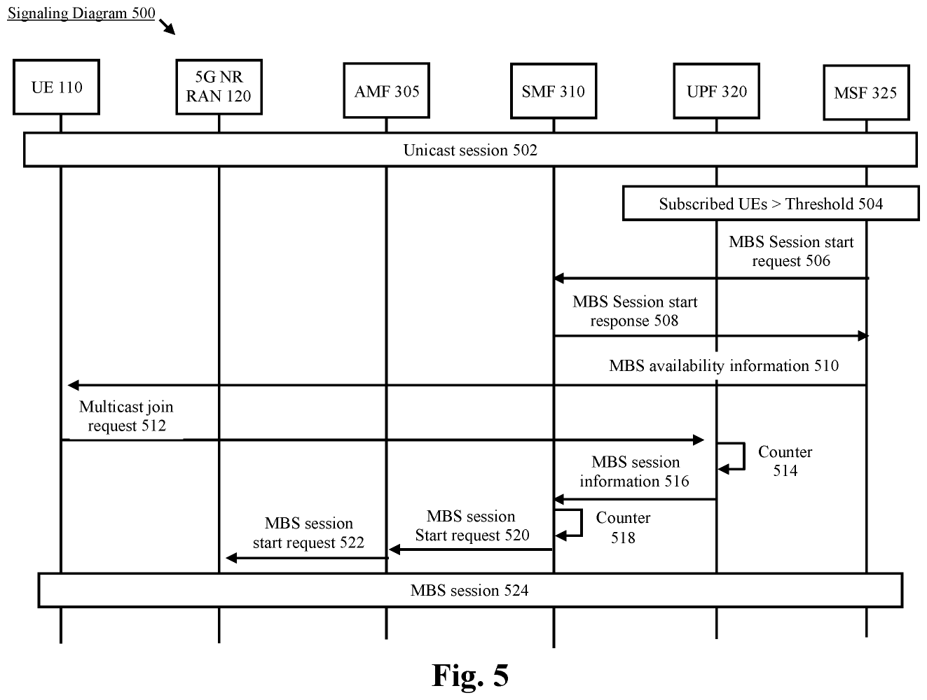

FIG. 5 shows a signaling diagram 500 for a unicast to multicast handover according to various exemplary embodiments. The signaling diagram 500 is described with regard to the network arrangement 100 of FIG. 1, the UE 110 of FIG. 2 and the schematic overview 300 of FIG. 3.

Like the signaling diagrams 400-450, the signaling diagram 500 relates to a scenario in which the UE 110 is currently configured with a unicast session. For example, the UE 110 may be camped on the 5G RAN 120 and receiving multimedia data for a network service via a PDU session. In contrast to the signaling diagrams 400-450, the signaling diagram 500 does not relate to a handover initiated by UE 110 mobility. Instead, the signaling diagram 500 relates to a handover initiated based on predetermined conditions identified on the network side corresponding to the user plane. The signaling diagram 500 includes the UE 110, the 5G NR RAN 120, the AMF 305, the SMF 310, the UPF 320 and the MSF 325.

The signaling diagram 500 describes three counters and corresponding thresholds. One counter may be implemented at the MSF 325, another counter may be implemented at the UPF 320 and a further counter may be implemented at the SMF 310. The manner in which these counters and/or thresholds may be utilized will be described below. However, the use of all three counters and thresholds is merely exemplary. Each counter and corresponding threshold may be standalone or can be used in conjunction with the other counters and corresponding thresholds.

In 502, a unicast session is in progress. In 504, the MSF 325 and/or UPF 320 identify that a number of UEs subscribed to receive the same content satisfy a predetermined threshold. For example, the network may implement a counter that tracks the number of UEs subscriber to receive the same content. This threshold may indicate to the network that an MBS session may be used to improve resource efficiency.

In 506, the MSF 325 sends an MBS session start request to the SMF 310. The MBS session start request may include information associated with a new MBS session such as, but not limited to, TMGI, duration, service area, TEID, MBS IP address, UPF IP address and tracking area information.

In 508, the SMF 310 sends an MBS session start response to the MSF 325. In 510, the MSF 325 may send MSB availability information to the UE 110 via the in progress unicast session. The MSB availability information may include information such as, but not limited to, an indication of an ongoing MBS session, a TMGI list, a relevant service area, etc.

In 512, the UE 110 transmits a multicast join request for an ongoing MBS session using the MBS availability information to the UPF 320. In 514, the UPF 320 uses a counter to track the number of requests for an MBS session ID. In this example, this counter may be used for MBS session management to ensure that the ongoing MBS session does not have too many or too few users.

In 516, the UPF 320 may send the SMF 310 MBS session information such as, but not limited to, the status of the counter and threshold implemented at the UPF 320, a TMGI list, a multicast request, etc.

In 518, the SMF 310 uses a counter to track the number of served UEs. This counter may be relevant to a particular tracking area and/or RAN and be used for MBS session management to ensure that the ongoing MBS session does not have too many or too few users.

In 520, the SMF 310 transmits the MBS session request to the AMF 305. In 522, the AMF 305 transmits the MBS session start request to the 5G NR RAN 120. In 524, the UE 110 connects to the MBS session via the UPF 320. In some embodiments, the unicast PDU session may be released. In other embodiments, the unicast PDU session may be modified. To ensure service continuity, the network may implement a guard timer or a QoS threshold condition prior to releasing or modifying the unicast PDU session.

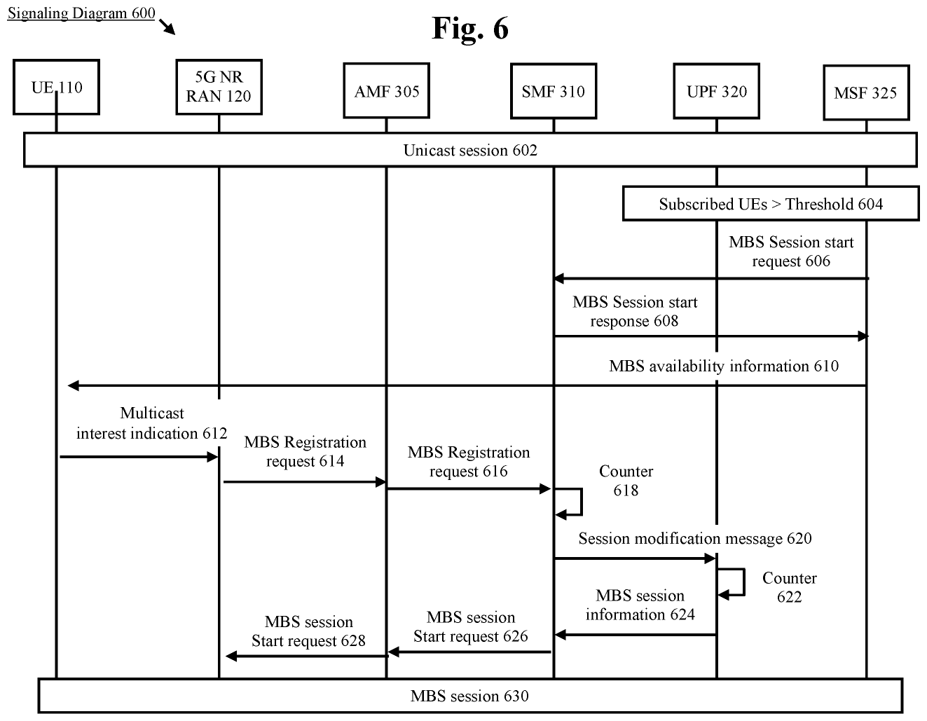

FIG. 6 shows a signaling diagram 600 for a unicast to multicast handover according to various exemplary embodiments. The signaling diagram 600 is described with regard to the network arrangement 100 of FIG. 1, the UE 110 of FIG. 2 and the schematic overview 300 of FIG. 3.

Like the signaling diagrams 400-500, the signaling diagram 500 relates to a scenario in which the UE 110 is currently configured with a unicast session. For example, the UE 110 may be camped on the 5G RAN 120 and receiving multimedia data for a network service via a PDU session. In contrast to the signaling diagrams 400-450, the signaling diagram 600 does not relate to a handover initiated by UE 110 mobility. Further, in contrast to the signaling diagram 500, the signaling diagram 600 does not relate to conditions corresponding to the user plane. Instead, the signaling diagram 600 relates to a handover initiated based on predetermined conditions identified on the network side corresponding to the control plane. The signaling diagram 600 includes the UE 110, the 5G NR RAN 120, the AMF 305, the SMF 310, the UPF 320 and the MSF 325.

Similar to the signaling diagram 500, the signaling diagram 600 describes three counters and corresponding thresholds. One counter may be implemented at the MSF 325, another counter may be implemented at the UPF 320 and a further counter may be implemented at the SMF 310. The manner in which these counters and/or thresholds may be utilized will be described below. However, the use of all three counters and thresholds is merely exemplary. Each counter and corresponding threshold may be standalone or can be used in conjunction with the other counters and corresponding thresholds.

602-610 are substantially similar to 502-510 of the signaling diagram 500. For example, in 602, an in progress unicast session is illustrated. In 604, the MSF 325 and/or UPF 320 identify that a number of UEs subscribed to receive the same content satisfy a predetermined threshold. In 606, the MSF 325 sends an MBS session start request to the SMF 310. In 608, the SMF 310 sends an MBS session start response to the MSF 325. In 610, the MSF 325 may send MSB availability information to the UE110 via the in progress unicast session.

In 612, the UE 110 transmits an MBS interest indication to the currently camped 5G NR RAN 120. This MBS interest indication may include the UE context such as, but not limited to, SUPI, PDU session ID, etc. The UE 110 may be triggered to transmit this request for any appropriate reason.

In 614, the 5G NR RAN 120 transmits an MBS registration request to the AMF 305. In 616, the AMF 305 forwards the MBS registration request to the SMF 310 with the TMGI requested by one or more UEs.

In 618, the SMF 310 uses a counter. If the counter at the SMF 310 is greater than predetermined threshold for MBS session users within the tracking area/RAN, the SMF 310 may forward this request to the UPF 320. If the counter does not satisfy the threshold, the MBS session may not be started. This counter may be used for MBS session management to ensure that enough UEs are to participate in the MBS session.

In 620, a session modification message is transmitted from the SMF 310 to the UPF 320. In response to this message, the UPF 320 may prepare the resources for the MBS session.

In 622, the UPF 320 uses a counter. If the counter at the UPF 320 is greater than predetermined threshold for MBS session users required for a multicast service, the UPF 320 may transmit MBS session information to the SMF 310. If the counter does not satisfy the threshold, the MBS session will not be started. This counter may be used for MBS session management to ensure that enough UEs are to participate in the MBS session.

In 624, the UPF 320 transmits MBS session information to the SMF 310. In some embodiments, the counter and corresponding threshold mentioned above with regard to 616 may be implemented at this time instead.

In 626, the SMF 310 transmits the MBS session start request to the AMF 305. In 628, the AMF 305 transmits the session start request to the 5G NR RAN 120. In 630, the UE 110 connects to the MBS session for multicast services via the UPF 320 for user plane data. In some embodiments, the unicast PDU session may be released. In other embodiments, the unicast PDU session may be modified. To ensure service continuity, the network may implement a guard timer or a QoS threshold condition prior to releasing or modifying the unicast PDU session.

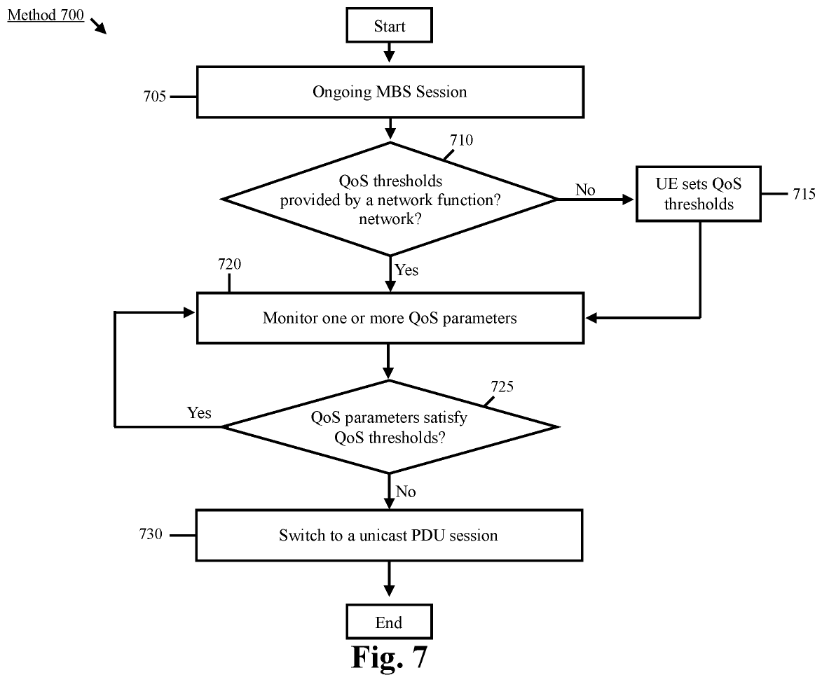

FIG. 7 shows a method 700 for multicast to unicast handover based on QoS according to various exemplary embodiments. The method 700 will be described with regard to the network arrangement 100 of FIG. 1 and the UE 110 of FIG. 2. The method 700 relates to operations performed on the UE 110 side.

In 705, the UE 110 is currently configured with an ongoing MBS session. In 710, the UE 110 determines whether QoS thresholds corresponding to the MBS session have been provided by a network function. For example, the UPF 320 and/or the MSF 325 may provide QoS thresholds before the MBS session is established, during MBS session establishment or after the MBS session has been established.

If QoS parameters have not been provided by a network function, the method 700 continues to 715. In 715, the UE 110 sets the QoS thresholds. The UE 110 may determine the QoS thresholds based on any appropriate factor such as, but not limited to, information stored locally at the UE 110 related to similar sessions, UE 110 capabilities, QoS for other similar sessions, the existence of concurrent data flows, the serving public land mobile network (PLMN), the type of cell, etc.

Regardless of whether the QoS parameters are provided by a network function of set by the UE 110, the method 700 continues to 720. In 720, the UE 110 monitors one or more QoS parameters. For example, during the MBS session the UE 110 may collect measurement data corresponding to over the air interface and/or performance data corresponding to the MBS session. This data may provide the basis for determining the QoS parameters.

In 725, the UE 110 determines whether the QoS parameters satisfy the QoS thresholds. If the QoS parameters do not fall below the QoS thresholds, the method 700 returns to 720 where the UE 110 continues to monitor the QoS Parameters. If the QoS parameters fall below the QoS thresholds, the method 700 continues to 730.

In 730, the UE 110 switches to a unicast PDU session. If there is already an ongoing unicast PDU session in parallel with the multicast session, the UE 110 may switch to the ongoing unicast PDU session. If there is not an ongoing unicast PDU session, the UE 110 may initiate a PDU session establishment procedure and switch to this PDU session after it is established. Subsequently, the method 700 ends.

In some embodiments, after the UE 110 switches to the unicast PDU session, the UE 110 may transmit an MBS session release request to terminate the MBS session and release the MBS bearer context. In other embodiments, the UE 110 may wait a predetermined amount of time and then check to see if the MBS session QoS has returned to acceptable levels.

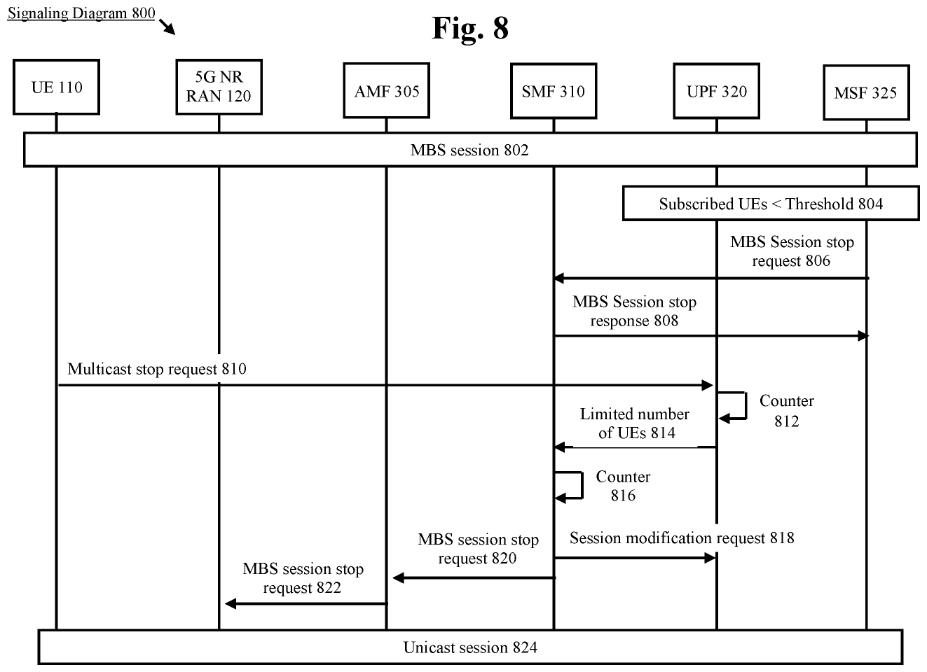

FIG. 8 shows a signaling diagram 800 for a multicast to unicast handover according to various exemplary embodiments. The signaling diagram 800 is described with regard to the network arrangement 100 of FIG. 1, the UE 110 of FIG. 2 and the schematic overview 300 of FIG. 3.

The signaling diagram 800 relates to a scenario in which the UE 110 is currently configured with a multicast session. For example, the UE 110 may be camped on the 5G RAN 120 and receiving multimedia data for a network service via an MBS session. The signaling diagram 800 includes the UE 110, the 5G NR RAN 120, the AMF 305, the SMF 310, the UPF 320 and the MSF 325.

In 802, an MBS session is in progress. At this time, the UE 110 may also be configured with an active unicast session for other network services. Similar to the signaling diagrams 500-600, the signaling diagram 800 describes three counters and corresponding thresholds. One counter may be implemented at the MSF 325, another counter may be implemented at the UPF 320 and a further counter may be implemented at the SMF 310. The manner in which these counters and/or thresholds may be utilized will be described below. However, the use of all three counters and thresholds is merely exemplary. Each counter and corresponding threshold may be standalone or can be used in conjunction with the other counters and corresponding thresholds.

In 804, the MSF 325 and/or UPF 320 identify that a number of UEs subscribed to receive the same content fall below a predetermined threshold. For example, the network may implement a counter that tracks the number of UEs subscribed to receive the same content. This threshold may indicate to the network that it is unnecessary to utilize and MBS session for this number of UEs.

In 806, the MSF 325 transmits an MBS session stop request to the SMF 310. For example, the MBS session stop request may travel to the SMF 310 via the UPF 320. In 808, the SMF 310 transmits an MBS session stop response to the SMF 310. As will be described below, the counters implemented at the UPF 320 and/or the counter implemented at the SMF 310 may provide the basis for the MBS session stop.

In 810, the UE 110 sends a multicast stop request to the UPF 320. This multicast stop request may include a PDU session ID, a TMGI and the SUPI of the UE 110. The UE 110 may be triggered to send this message for any appropriate reason.

In 812, the UPF 320 uses a counter. As mentioned above with regard to the signaling diagrams 500-600 the counter may be used for MBS session management to ensure MBS session does not have too many or too few users. In this example, it is assumed that the counter falls below the predetermined threshold.

In 814, the UPF 320 sends an indication to the SMF 310 that a limited number of UEs are accessing the MBS session. In 816, the SMF 310 uses a counter. As mentioned above with regard to the signaling diagrams 500-600 the counter may be used for MBS session management to determine whether the UEs in different TMGI, service areas, RNAs, etc. are accessing the multicast session. The counter may be incremented based on the indication in 814 and/or any other appropriate factor.

In 818, the SMF 310 sends a session modification request to the UPF 320 with TMGI and an MBS session stop request. This MBS session stop request may serve a variety of different purposes. For example, the MBS session stop request may be specific to the UE 110 due to the multicast stop request transmitted in 810. Alternatively, this request may be specific to TMGI, a service area of the whole MBS session based on any one or more of the counters mentioned above.

In 820, the SMF 310 may transmit the MBS session stop request to the AMF 305. In 822, the AMF 305 may forward the MBS session stop request to the 5G NR RAN 120.

In 824, the UE 110 connects to the existing MBS session using an ongoing PDU session via unicast or by establishing a new PDU session.

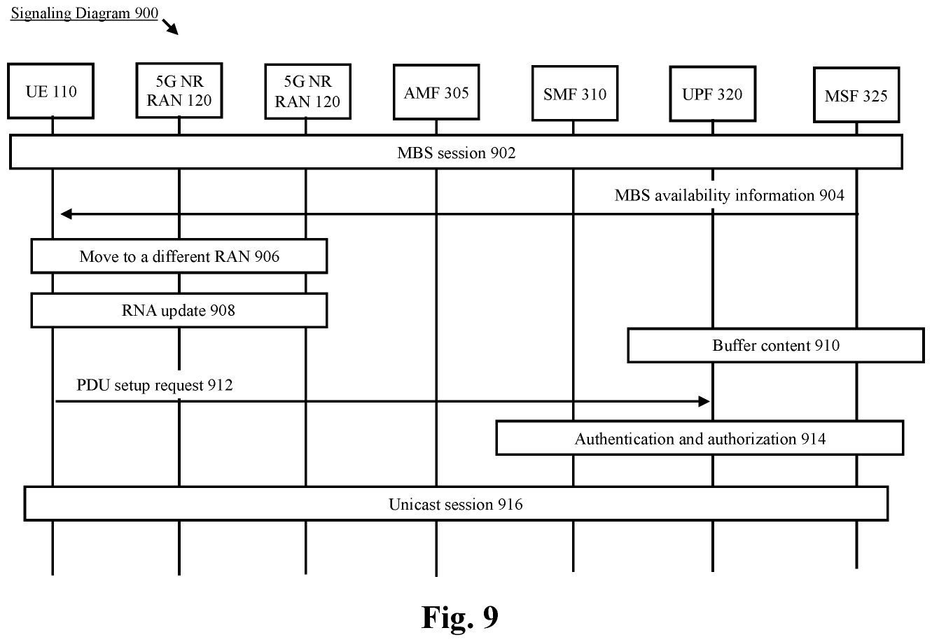

FIG. 9 shows a signaling diagram 900 for a multicast to unicast handover according to various exemplary embodiments. The signaling diagram 900 is described with regard to the network arrangement 100 of FIG. 1, the UE 110 of FIG. 2 and the schematic overview 300 of FIG. 3.

The signaling diagram 900 relates to a scenario in which the UE 110 is currently configured with a multicast session and moves to a RAN that does not support MBS. The signaling diagram 900 includes the UE 110, the 5G NR RAN 120, the 5G NR RAN 122, the AMF 305, the SMF 310, the UPF 320 and the MSF 325.

In 902, an MBS session is in progress. In 904, the MSF 325 transmits MBS availability information to the UE 110. The MBS availability information may include an indication of an ongoing MBS session and MBS bearer context such as a TMGI list, a service area list and other session information for the ongoing MBS session. The MBS availability information may travel from the MSF 325 to the UE 110 via the application layer and the user plane. Further, the MBS availability information may be provided to the UE 110 for any appropriate reason such as, but not limited to, an active MBS session, an indication of UE 110 mobility, the presence of an ongoing and relevant MBS session within the vicinity of the UE 110, the initiation of an MBS session, etc.

In 906, the UE 110 moves to a different RAN. For example, the UE 110 may be camped on the 5G NR RAN 120 and then move to the 5G NR RAN 122. In this example, the 5G NR RAN 122 does not support MBS. In 908, the UE 110 performs RNA update on the 5G NR RAN 122.

In 910, the MSF 325 and/or the UPF 320 may buffer the content for the UE 110. For example, in anticipation that the UE 110 may attempt to resume the session using a unicast PDU session, the MSF 325 and/or the UPF 320 may buffer the content data. If the MSF 325 and/or the UPF 320 identify a unicast request includes information associated with the UE 110, the MSF 325 and/or the UPF 320 may resume the session and include the buffer data such that the user of the UE 110 does not miss any content.

In 912, the UE 110 transmits a PDU setup request to the UPF 320. This request may include an indication of the previous MBS session. For example, the request may include TMGI and a session ID. This allows the network to determine that the buffered content data is intended for the UE 110.

In 914, authentication and authorization is performed amongst various network functions (e.g., the SMF 310, the UPF 320, the MSF 325, and other appropriate network functions) for user plane and control plane activation of the unicast session. In 916, the UE 110 establishes the unicast session to continue the data flow. In some embodiments, this may be a new PDU session. In other embodiments, this PDU session may be ongoing in parallel to the MBS service.

The exemplary embodiments are not limited to unicast to multicast handover or vice versa. As will be described below, there may be other reasons for the UE 110 to switch between unicast and multicast.

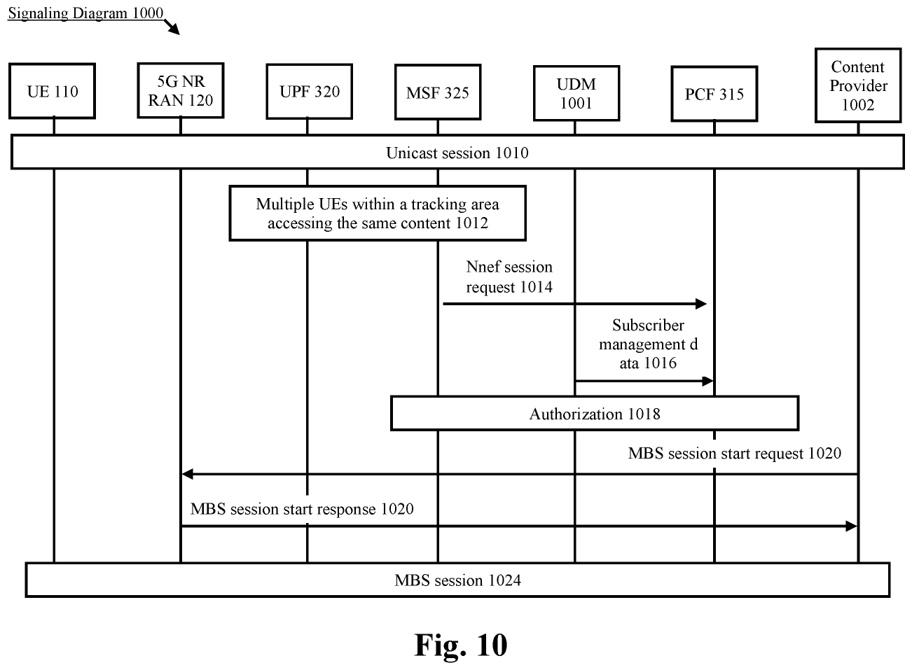

FIG. 10 shows a signaling diagram 1000 for facilitating a unicast to multicast switch for the UE 110 according to various exemplary embodiments. The signaling diagram 1000 includes the UE 110, the 5G NR RAN 120, the UPF 320, the MSF 325, the PCF 315 a unified data management (UDM) 1001 and a content provider 1002.

In 1010, the UE 110 a unicast session is in progress. In 1012, the UPF 320 and/or the MSF 325 identify that multiple UEs within a tracking area are accessing the same content. This may indicate to the network that an MBS session may be beneficial for network resource efficiency.

In 1014, the MSF 325 may send a Nnef session request to the PCF 315. The Nnef session request may include a data network name (DNN), an identity of the MSF 325, an indication of the type of requested traffic (e.g. MBS) and an indication of the content to be accessed.

In 1016, the UDM 1001 sends subscriber management data to the PCF 315. Those skilled in the art will understand that the UDM 1001 generally refers to a centralized network component that manages network user data. This subscriber management data may include, but is not limited to, SUPI, TMGI, the type of requested traffic (e.g., MBS) and whether access to the requested content is permitted.

In 1018, authentication is performed amongst various network functions (e.g., the MSF 325, UDM 1001 and the PCF 315) and the content provider 10002. In this example, MBS for the specific content is permitted.

In 1020, an MBS session start request is transmitted to the 5G NR RAN 120 from the content provider 1002 via the MSF 325. Although not shown in the signaling diagram 1000, this request may be received and forwarded by various network components. In 1022, the MBS session start response is transmitted from the 5G NR RAN 120 to the content provider via the MSF 325. In 1024, the UE 110 connect to the MBS session and receives multicast service from the content provider 1002.

In contrast to the signaling diagram 1000, if the UE 110 wanted to switch from an MBS session to a unicast session, the UE 110 may utilize a PDU session modification or create request to join an already in progress PDU session. However, if there was not an already in progress PDU session, additional signaling may be on the network side performed to perform the switch and establish the unicast PDU session. For example, the MSF 325 may send an Nnef create or modify request to PCF 315 for content delivery through the requested PDU session. This may also signify that MSF 325 shall add the multicast session content to the unicast delivery contents. The PCF 315 may also check with the UDM 1001 to ensure that the UE 110 has the subscription to receive the requested content. Once authentication is complete, the UE 110 may have direct content delivery from the content provider 1002 via the unicast PDU session.

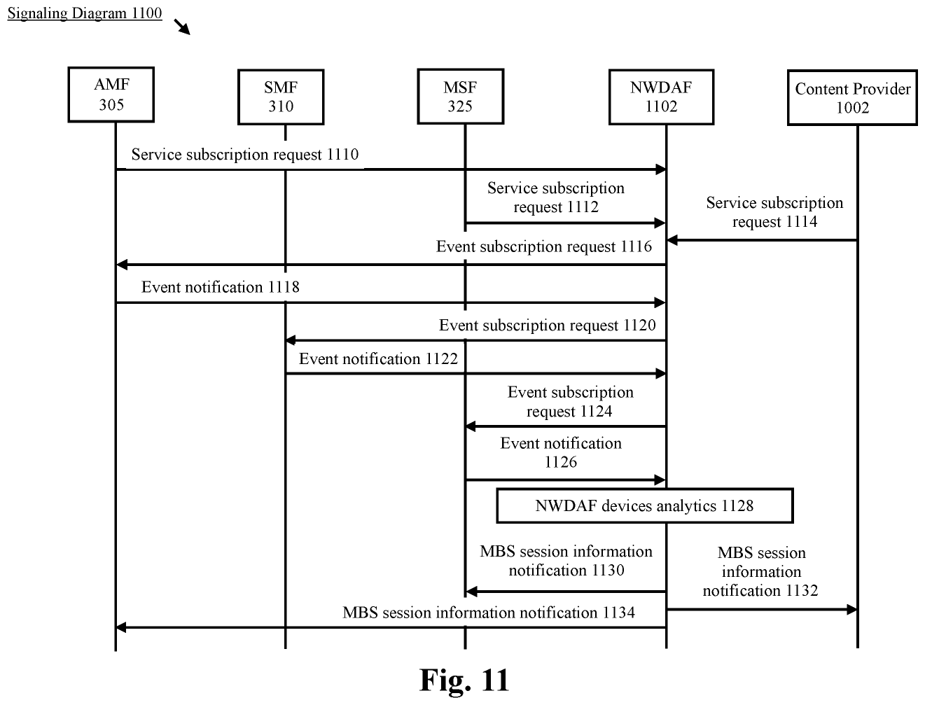

FIG. 11 shows a signaling diagram 1100 for collecting and analyzing data by a network data analytics function (NWDAF) 1102 to be used for unicast to multicast switching and vice versa according to various exemplary embodiments. Those skilled in the art will understand that the NWDAF 1102 is a network function that performs operations for network automation such as receiving input from other network components (e.g., network functions, UEs, cells, etc.), performing an analysis on the input and generating an output based on the analysis. However, reference to an NWDAF is merely provided for illustrative purposes, different entities may refer to a similar concept by a different name. Accordingly, the NWDAF as described herein may represent any mechanism used to perform analytics for network automation.

During operation, various network nodes may provide input and receive output from the NWDAF 1102 to perform various aspects of network automation. In 1110, the AMF 305 may send a request to subscribe to the services of the NWDAF 1102. Similarly, in 1112 and 1114, the MSF 325 and the content provider 1002, respectively, request to subscribe to the services of the NWDAF 1102. It is noted that in this example, there is no corresponding subscription request from the SMF 310 because the SMF 310 may not receive services from the NWDAF 1102, e.g., the SMF 310 is only reporting data to the NWDAF 1102, it is not receiving any output as will be described in greater detail below. On the other hand, the AMF 305 and/or the MSF 325 are requesting services of the NWDAF 1102 and therefore are requesting to subscribe to these services.

In 1116, 1120 and 1124, the NWDAF 1102 requests to subscribe to events of the AMF 305, SMF 310 and MSF 325, respectively, to receive information from these nodes. The various network nodes may then begin reporting information to the NWDAF 1102 via event notifications. For example, in 1118, the AMF 305 may provide the NWDAF 1102 with input that includes, UE mobility information, a count of UEs in different RNAs, TMGI related information, etc. In 1122, the SMF 310 may provide input that includes a count of PDU sessions supporting different MBS sessions. In another example, in 1126, the MSF 325 may provide input that includes a count of UEs in respective service areas, active content types in different TMGI, different content types available, etc.

In 1128, the NWDAF 1102 may process the information received from the various network nodes and generate output based on any appropriate type of information. The output may be delivered to the various nodes that have subscribed to the NWDAF services (e.g., the AMF 305, the MSF 325 and the content provider 1002) via an MBS session information notification. For example, in 1134, the NWDAF 1102 may provide the AMF 305 with analytics that provide the basis for automatic MBS session activation and deactivation in different RNAs. In another example, in 1130, the NWDAF 1102 may provide the MSF 325 with analytics that provide the basis for automatic MBS session activation and deactivation per content delivery. In a further example, in 1130, the NWDAF 1102 may provide the MSF 325 with analytics that provide the basis for automatic session activation and deactivation for different service area IDs. In 1132, the NWDAF 1102 may provide the output to the content provider 1002 so the content provider understands the type(s) of data delivery that are being used for their content. Thus, the NWDAF 1102 may provide output that is used to ensure that resources are used efficiently based on expected network load.

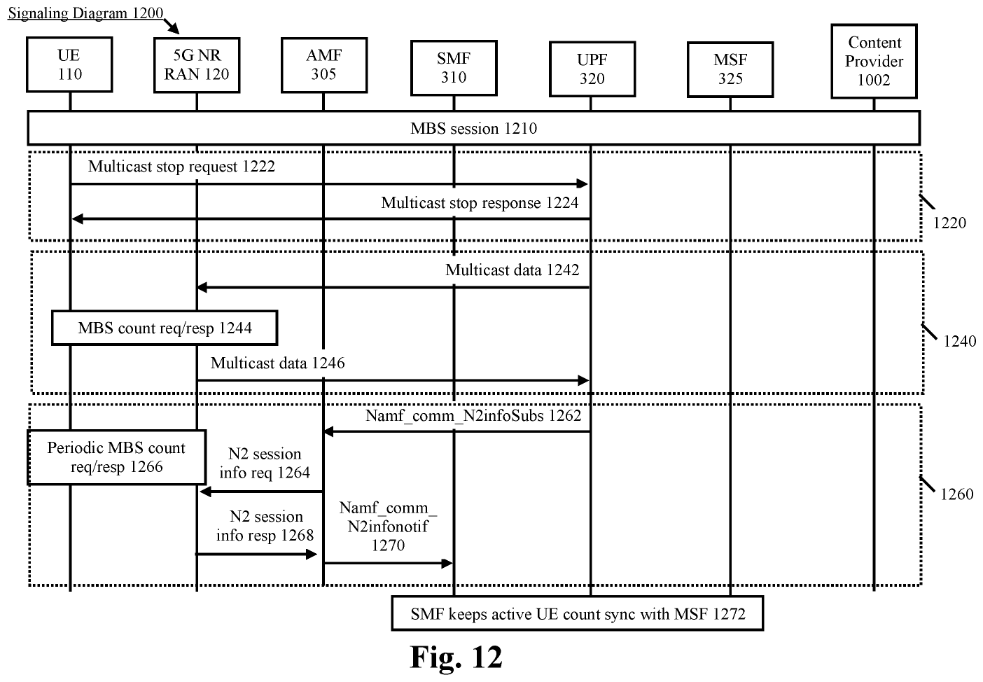

FIG. 12 shows a signaling diagram 1200 for UE 110 and network synchronization with regard to MBS sessions according to various exemplary embodiments. It should be understood that the signaling diagram 1200 includes three different scenarios of signaling related to synchronization. These different scenarios may be related to various cases that arise during an MBS session. The first exemplary scenario 1220 is related to the UE 110 directly requesting the UPF 320 for an action related to the MBS session. The second exemplary scenario 1240 is related to the UPF 320 requesting data from the 5G NR RAN 120 related to the MBS session. The third exemplary scenario 1260 is related to the SMF 310 of the content provider 1002 keeping an active UE count for an MBS session. It should be understood that the signaling related to these exemplary scenarios may be implemented individually or may be used in conjunction with signaling from other scenarios.

In 1210, it may be considered that there is an active MBS session in progress for the UEs 110. This active MBS session may be a precursor for each of the scenarios 1120, 1140 and 1160.

In the scenario 1220, a UE 110 may signal to the UPF 320 that the UE 110 is no longer interested in a particular MBS session. For example, when the UE 110 switches off an application or content channel it would be a waste of network resources to continue to provide the MBS service as if the UE 110 were still interested in watching the content provided. Accordingly, in response to an event at the UE 110 such as quitting an application or switching a content channel, in 1222, the UE 110 may be triggered to send a multicast stop request to the UPF 320. This multicast session stop request may include information such as, but not limited to, TMGI, SUPI, session ID, etc. In response, in 1224, the network may provide the UE 110 with a multicast stop response.

In the scenario 1240, the UPF 320 and/or the MSF 325 may keep a count of active UEs 110 with regard to MBS sessions. For example, in 1242, the UPF 320 may transmit a multicast data request to the 5G NR RAN 120. This request may include a UE count request per TMGI accessing the contents. In. 1244, the 5G NR RAN 120 may broadcast an MBS count request to connected UEs 110 and may then receive a response for one or more connected UEs 110. In 1246, the 5G NR RAN 120 provides a multicast response to the UPF 320 with an active count of UEs per multicast session. In 1248, the UPF 320 and/or MSF 325 may keep count of active UEs over respective multicast sessions and thus, can use this information for efficient resource utilization.

In the scenario 1260, the SMF 310 may keep count of active UEs 110 with regard to MBS sessions. For example, in 1262, the SMF 310 may transmit a request to the AMF 305. The request may include a Namf communication N2 information subscription request for active UE accessing respective multicast sessions with session ID and TMGI. In 1264, the AMF 305 may forward this request to the 5G NR RAN 120 with N2 session information request. In 1266, the 5G NR RAN 120 may keep count of active UEs per multicast session. In 1268, the 5G NR RAN 120 may then provide the count to the AMF 305 in a N2 session information response. In 1270, the AMF 305 may then forward to count to the SMF 310 in a Nammf communication N2 information notification. In 1272, the SMF 310 may then keep count of active UEs over different sessions on multicast and thus, sync with service function control plane for session activation and suspension.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
at a user equipment (UE):
receiving first data from a network via unicast;
receiving first information from the network, the first information indicating the availability of a multicast service;
transmitting second information to the network; and
receiving second data from the network via multicast in response to transmitting the second information to the network.

2. The method of claim 1, wherein an active multicast session is available prior to transmitting the second information and wherein receiving the second data includes joining the active multicast session.

3. The method of claim 2, wherein the first data is received while camped on a first radio access network (RAN) and the active multicast session is on a second different RAN, wherein the UE camps on the second RAN based on the first information.

4. The method of claim 1, wherein the first information identifies a radio access network (RAN) and wherein the second information indicates to the RAN that the UE is interested in a multicast session, the second information including an identity of the UE and a packet data unit (PDU) identity for a session used to receive the first data.

5. The method of claim 4, wherein the multicast session is initiated by the network based on the information received from the UE and a plurality of further UEs.

6. The method of claim 1, wherein the first information indicates an active multicast session on a currently camped radio access network (RAN).

7. The method of claim 6, wherein the second information is a multicast join request transmitted to a user plane function (UPF) of the network, the multicast join request includes at least one of a group identity, a UE identity, a tracking area identity or a packet data unit (PDU) identity for a session used to receive the first data.

8. The method of claim 6, wherein the second information is a multicast interest indication transmitted to the RAN, the multicast interest indication including at least one of a UE identity a packet data unit (PDU) identity for a session used to receive the first data.

9. A user equipment (UE), comprising:
a transceiver configured to communicate with a network; and
a processor configured to perform operations, the operations comprising:
receiving first data from a network via unicast;
receiving first information from the network, the first information indicating the availability of a multicast service;
transmitting second information to the network; and
receiving second data from the network via multicast in response to transmitting the second information to the network.

10. The UE of claim 9, wherein the first information identifies a radio access network (RAN) and wherein the second information indicates to the RAN that the UE is interested in a multicast session, the second information including an identity of the UE and a packet data unit (PDU) identity for a session used to receive the first data.

11. A method, comprising:
at a user equipment (UE):
receiving first information from the network, the first information indicating the availability of a multicast service;
receiving first data from the network via a multicast session; and
receiving second data from the network via a unicast packet data unit (PDU) session.

12. The method of claim 11, further comprising:
monitoring a quality of service (QoS) parameter associated with the multicast session, wherein the QoS threshold is indicated to the UE by a network function or set by the UE;
determining whether the QoS parameter satisfies the QoS threshold; and
when the QoS parameter does not satisfy the QoS threshold, switching from the multicast session to the unicast session.

13. The method of claim 11, further comprising:
transmitting a request to stop the multicast session, the request including at least one of a group identity, a UE identity, a tracking area identity or a packet data unit (PDU) identity for a session used to receive the first data.

14. The method of claim 11, further comprising:
camping on a first radio access network (RAN), wherein the first data is received while camped on the first RAN;
camping on a second RAN after camping on the first RAN;
identifying that the second RAN does not support multicast service; and
transmitting a request for the unicast PDU session.

15. The method of claim 14, wherein the request is transmitted to a user plane function (UPF).

16. The method of claim 11, wherein the UE switches from the multicast session to the unicast PDU session based on a network function identifying that a counter does not satisfy a threshold value.

17. The method of claim 16, wherein the counter corresponds to a number of UEs associates with the multicast service and the network function is one of a user plane function (UPF), a multicast service function (MSF) or a session management function (SMF).

18. A user equipment (UE), comprising:
a transceiver configured to communicate with a network; and
a processor configured to perform operations, the operations comprising:
receiving first information from the network, the first information indicating the availability of multicast service;
receiving first data from the network via a multicast session; and
receiving second data from the network via a unicast packet data unit (PDU) session.

19. The UE of claim 18, wherein the first data and the second data are received by the UE while camped on a new radio (NR) radio access network (RAN).

20. The UE of claim 18, wherein the UE switches from the multicast session to the unicast PDU session based on a network function identifying that a counter does not satisfy a threshold value.
